(19) United States
(12) Patent Application Publication
(10) Pub. No.: US 2002/0156923 A1
(43) Pub. Date: Oct. 24, 2002

(54) Server device and network system

(75) Inventor: Yoshifumi Tanimoto, Uji-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/124,042

(22) Filed: Apr. 16, 2002

(30) Foreign Application Priority Data
Apr. 19, 2001 (JP) 2001-120958
Apr. 24, 2001 (JP) 2001-125547

(51) Int. Cl. G06F 15/16

(52) U.S. Cl. 709/246; 709/219

(57) ABSTRACT

A server device for enabling a client PC to refer to image data corresponding to the image processing ability of the client PC. A facsimile server device is a server device connected to client PCs via the LAN. The facsimile server device is capable of storing received or scanned image data, and includes image converting means for converting the stored image data into a specific image data format, based on the indication message from the client PC, displaying means for displaying the stored image data in a thumbnail, and downloading means for downloading the converted image data to the client PC.

### CROSS REFERENCES TO RELATED APPLICATIONS

This application claims priority under 35 USC 119 of Japanese Patent Application Nos. 2001-120958, and 2001-125547 filed in JPO on Apr. 19, 2001 and Apr. 24, 2001, respectively, the entire disclosures of which are incorporated herein by reference.

### BACKGROUND OF THE INVENTION

1. Field of the Invention

The present invention relates to a server device provided with an HTTP server function, and more specifically to a facsimile server device for transmitting and receiving image data by communication means such as electronic mail or G3 facsimile.

2. Description of the Related Art

A facsimile system has been practically used, where a facsimile server device which is connected to a public switched telephone network or the like and which is provided with a facsimile transmitting and receiving function, and a client device such as a personal computer are connected to each other via a LAN (Local Area Network). According to a conventional facsimile system, by transmitting a transmission indicating signal including image data and information of the destination to the facsimile server device from the client device, the facsimile server device transmits the image data via a public line to the destination. Furthermore, when the facsimile server device receives the image data, the facsimile server device transmits the image data to a designated client device, and thereby, the client device receives the image data.

Moreover, when the facsimile server device is provided with an HTTP (WWW) server function, browser (for example, a browsing program for reading and displaying, or data inputting or setting, or supervisory controlling of the data which was stored in the HTTP server device via a communication line such as the Internet or the LAN) means of a client personal computer (hereafter, referred to as the client PC) holds the image data received by facsimile, and it is possible to refer to the image data from the browser of the client PC.

However, at a PDA (Personal Digital Assistant) or the like which is a small personal computer, it is possible to refer to the only image data corresponding to the ability of the client PC such as the PDA. For example, since the only TIFF (Tagged Image file format) file can be handled at the PDA, when receiving the image data of an MH (Modified Huffman) format, there is a problem in that image processing such as displaying cannot be carried out by the PDA.

Moreover, when the facsimile server device transmits the image data to a terminal of the destination such as a G3 facsimile machine, the image data of the transmission original which was scanned by the facsimile server device at the time of the transmission is deleted without being saved after being transmitted.

Therefore, for example, when resending the image data which was transmitted before to the same terminal of the destination, or when transmitting the image data which was transmitted before to a terminal of a different destination, it was necessary for the image data of the transmission original to be scanned by the facsimile server device again, and then transmitted. In such a case, there was a problem in that since the transmission original has been already filed, or in some cases, already discarded, it took time to re-scan the transmission original again.

### SYMMARY OF THE INVENTION

With the view of the foregoing, a first object of the present invention is to provide a server device for enabling a client PC to refer to the image data in accordance with the ability of the client PC, and a network system provided with the server device.

A second object of the present invention is to provide a server device which does not require re-scanning of the original when retransmitting the original.

According to one aspect of the present invention, there is provided a server device which comprises HTTP server means and is connected to a client device via a private line, wherein the HTTP server means includes storing means for storing the image data, and converting means for converting the image data stored in the storing means into a specific image data format, based on the indication generated from the client device.

Preferably, the private line is a LAN (Local Area Network).

Preferably, the server device comprises facsimile server means which includes receiving means for receiving the image data via the public line, and includes outputting means for outputting the received image data to the HTTP server means.

Preferably, the public line is a PSTN (Public Switched Telephone Network) or the Internet.

Preferably, the facsimile server means comprises scanning means for obtaining the image data by scanning the original, and the outputting means for outputting the image data obtained by the scanning means to the HTTP server means.

Preferably, the HTTP server means includes downloading means for downloading the converted image data to the client device, based on the indication generated from the client device.

Preferably, the converting means converts the image data, concerning at least one of the paper size, the resolution, the coding method, and the file format.

Preferably, the HTTP server means comprises determining means for determining whether or not the image data has been stored in the storing means, and notifying means for sending, to the client device, a notification report to the effect that the image data has been stored in the storing means, when the image data is stored in the storing means.

Preferably, the notifying means sends the notification report to the client device in the form of the electronic mail.

According to another aspect of the present invention, there is provided a network system, wherein a client device and a server device are connected to each other via a private line. The server device comprises storing means for storing the image data and converting means for converting the image data stored in the storing means into the specific image data format, based on the indication generated from the client device. Moreover, the client device comprises displaying means for displaying the information concerning the image data stored in the storing means.

Preferably, the information concerning the image data includes at least one of the date and time of receiving, the telephone number of the transmitter, the number of pages, and a read state or unread state, regarding each image data.

Preferably, the image data stored in the storing means is displayed in a thumbnail by the displaying means.

According to the above-mentioned present invention, since conversion of the image data is performed at the server device side, even in the case of the client device such as a PDA or a portable terminal whose ability for converting the image data is low compared with a personal computer, it is possible to refer to the image data under the most appropriate condition.

Moreover, after the image data is converted, the converted image data can be downloaded to the client device, and the subsequent image processing can be carried out by the client device.

Moreover, since the converting means carries out the image conversion to at least one of the paper size, the resolution, the coding method, and the file format of the stored image data, the image data can be converted into an image format desired by the client device.

According to another aspect of the present invention, there is provided a server device comprising HTTP server means and facsimile server means, wherein the facsimile server means is provided with transmitting means for transmitting the image data through a public line, transmission management data composing means for composing the transmission management data of the image data transmitted by the transmitting means, and outputting means for outputting, to the HTTP server means, through the private line, the image data transmitted by the transmitting means and the transmission management data.

Preferably, the HTTP server means saves (or stores) the image data and the transmission management data input by the outputting means.

Preferably, the transmission management data includes at least one of the date and time of the transmission, the number of pages, the data of the destination of the transmitted image data, and the transmission result received from the destination, regarding the transmitted image data.

Preferably, the HTTP server means comprises retransmitting means for carrying out the retransmission of the saved image data, based on the indication generated from the client device.

Preferably, the retransmitting means retransmits a part of the saved image data, based on the indication generated from the client device.

According to the above-mentioned present invention, when carrying out the retransmission of the image data, the image data saved in the HTTP server means can be retransmitted without re-scanning of the original. Thus, it is convenient for a user or the like, and it is efficient.

Moreover, the retransmission can be indicated to the facsimile server means from any HTTP client devices which can carry out the communication with the facsimile server means, and as a result, it is convenient for the users.

According to another aspect of the communication system or the electronic mail communication device of the present invention, after the electronic mail with the delivery confirmation demand is transmitted, the transmission right reversing command is transmitted, and then the delivery confirmation demand can be replied without disconnecting the session. Therefore, compared with the case in which the session is established again, and then the delivery confirmation is transmitted as in a conventional manner, a reply to the delivery confirmation demand can be sent sooner, and it is possible to efficiently transmit the electronic mail of the delivery confirmation.

### BRIEF DESCRIPTION OF THE DRAWINGS

FIG. 1 is a block diagram showing the structure of a facsimile system 1 comprising a facsimile server device 20 having an HTTP server function, according to a first embodiment of the present invention;

FIG. 2 is a block diagram showing the structure of a client PC 30 of FIG. 1;

FIG. 3 is a block diagram showing the structure of the facsimile server device 20 of FIG. 1;

FIG. 4 is a view showing a screen concerning “the image data of the received facsimile” which is displayed when accessing the facsimile server device 20;

FIG. 5 is a view showing a screen which is displayed when clicking “read” or “unread” in “the image data of the received facsimile” of FIG. 4, and shows a screen for generating an indicating signal which indicates the thumbnail display of the image data of the received facsimile and the conversion of the image format when downloading;

FIG. 6 is a block diagram showing the structure of facsimile server means 101 according to a fourth embodiment of the present invention;

FIG. 7 is a block diagram showing the facsimile server means 101 of FIG. 6 and the network structure;

FIG. 8 is a flow chart showing the working of a facsimile server device (B) of FIG. 7 when transmitting the image data of the original;

FIG. 9 is a flow chart showing the working of the facsimile server device (B) when retransmitting the saved image data;

FIG. 10 is a view showing an example of the display of the menu of the browser in the case of retransmitting or the like of the saved image data;

FIG. 11A and FIG. 11B are views showing an example of the display of the browser in the case of retransmitting of the saved image data;

FIG. 12 is a flow chart showing the working of the facsimile server device (B) when transmitting the saved image data to a different destination;

FIG. 13A and FIG. 13B are views showing an example of the display of the browser when transmitting the saved image data to a different destination;

FIG. 14A and FIG. 14B are views showing an example of the display of the browser when deleting the saved image data; and

FIG. 15A and FIG. 15B are views showing an example of the display of the browser at the time of thread displaying of the saved image data.

### DETAILED DESCRIPTION OF THE INVENTION

### First Embodiment

A first embodiment of the present invention will now be described in reference to the accompanying drawings.

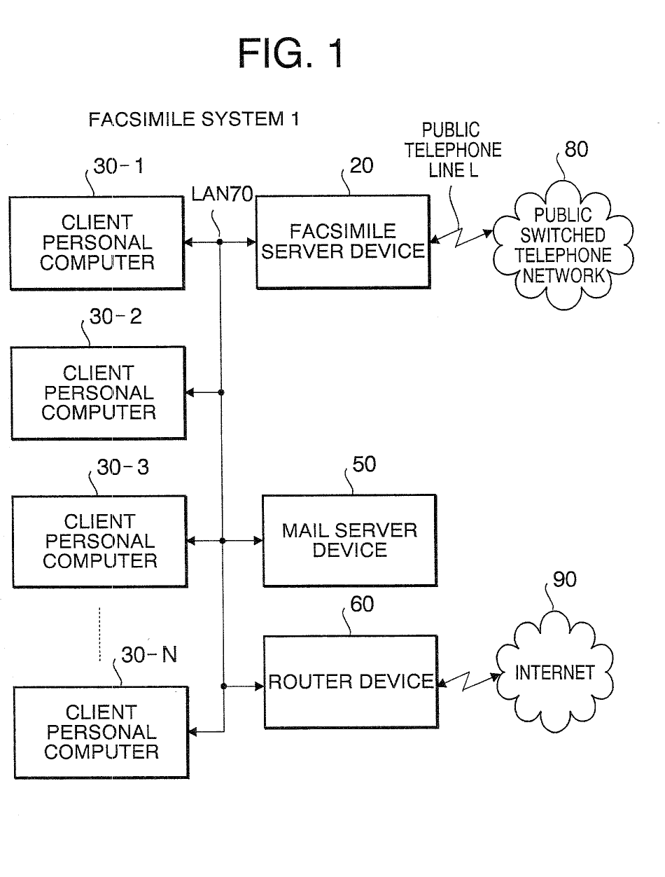

In FIG. 1, the structure of a facsimile system 1 is shown which is a network system provided with a facsimile server device 20 having HTTP server (also known as a WWW (World Wide Web) server) means.

By providing the facsimile machine 20 with the HTTP server means, client PCs 30-1 to 30-N (hereafter, referred to as the client PC 30 in some cases) can access data written in HTML (Hyper Text Markup Language) used for home pages in order to carry out a predetermined HTTP (Hyper Text Transfer Protocol) task. The HTTP task includes a task for carrying out a predetermined processing such as forwarding of the data of a database to the client PCs 30-1 to 30-N so as to display the forwarded data, converting of a format of the image data, and downloading. The facsimile system 1 is formed with a plurality of the client PCs 30-1 to 30-N, the facsimile server device 20 which is connected to a public switched telephone network 80 via a public telephone line (L), a mail server device 50, a router device 60 which is connected to the Internet 90, and a LAN 70 which is a private line. Each of the devices 30, 20, 50, 60 is connected to each other through the LAN 70.

The facsimile server device 20 is a server device with a facsimile function which is connected to the client PCs 30-1 to 30-N via the LAN 70, the public switched telephone network 80 or/and the like. The facsimile server device 20 comprises storing means for storing image data obtained by receiving or obtained by scanning the original, image converting means for converting the stored image data into a predetermined image data format based on indication message data obtained from each of the client PCs 30-1 to 30-N by using the HTTP browser, displaying means for displaying the stored image data at a thumbnail, and downloading means for downloading the converted image data to the client PCs 30-1 to 30-N. A program area 9a of these mean's is provided in a hard disk drive 9 of the facsimile server device 20.

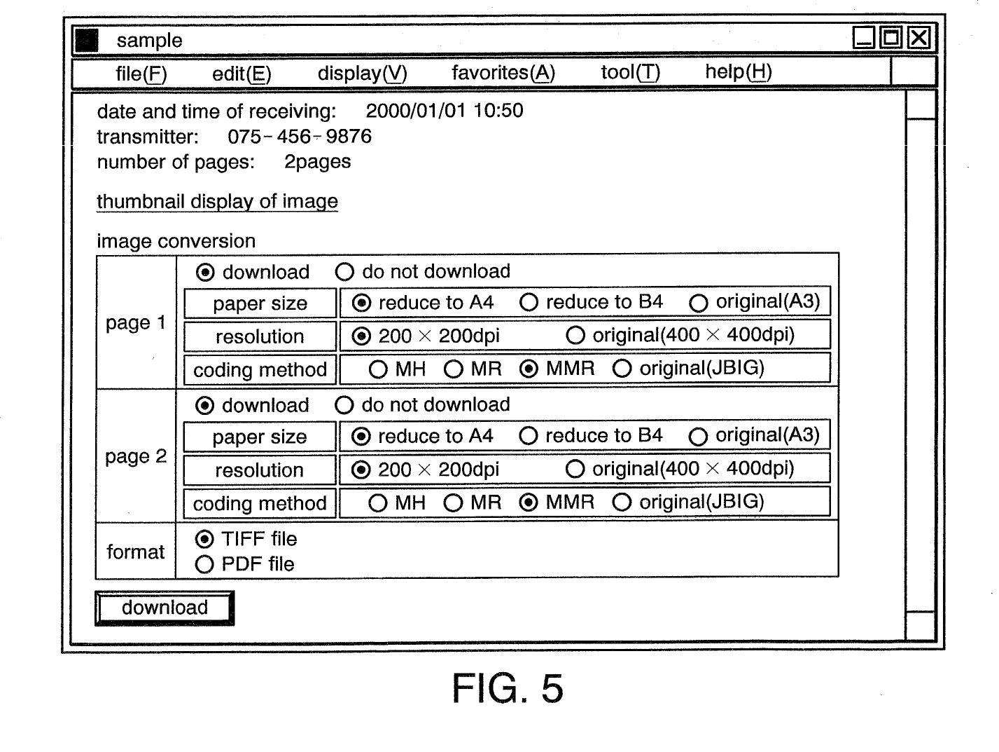

As shown in FIG. 5, on the browser of the HTTP of the client PCs 30-1 to 30-N, the image converting means carries out conversion of the stored image data, concerning at least one of the paper size, the resolution, the coding method, and the file format.

As shown in FIG. 1, the mail server device 50 receives electronic mail from a mail server device (not shown in the drawings) of the other end via the Internet 90 and the LAN 70. When the received electronic mail includes the image data coded under the MIME (Multipurpose Internet Mail Extensions) format, the mail server device 50 holds the electronic mail including this image data. At this time, the electronic mail including the image data is forwarded to the facsimile server device 20, the decoding processing is carried out, and the decoded image data is held by an image memory 8 of the facsimile server device 20.

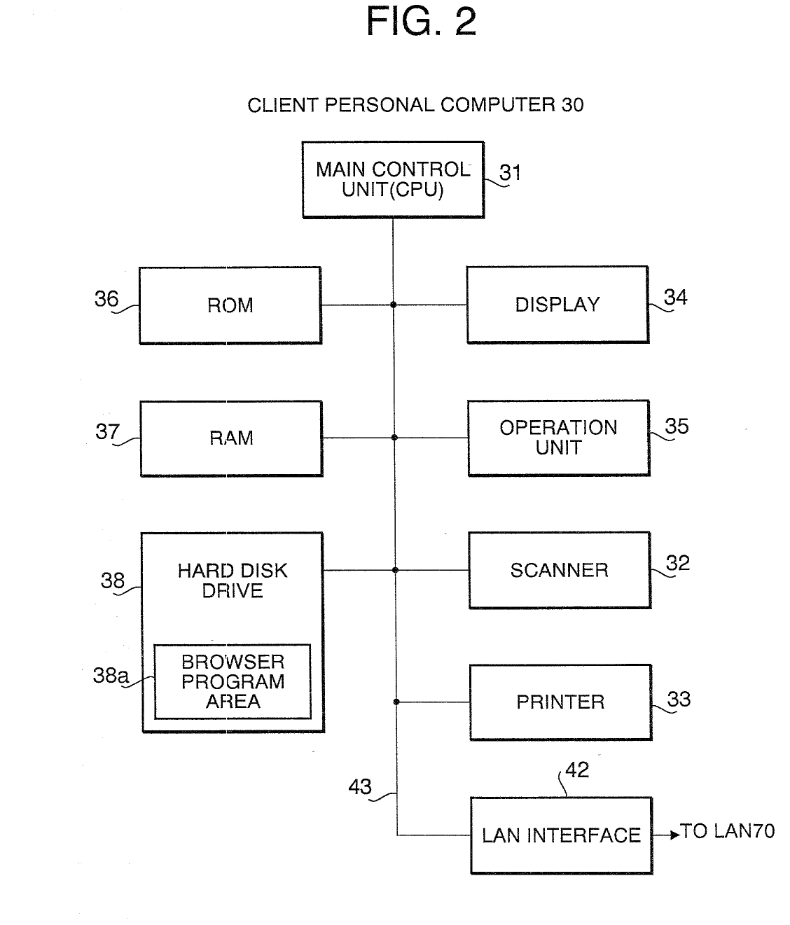

As shown in FIG. 2, the client PC 30 is a known personal computer, and carries out the processing such as generating and recording of the image data or the character data. In the first embodiment of the present invention, as an example, the client PC 30 is used as a client terminal device for transmitting and receiving the image data of the facsimile.

Specifically, a main control unit 31 is formed so as to include a CPU (Central Processing Unit), is connected to each hardware unit, and controls each hardware. The main control unit 31 carries out various software functions to be described hereinbelow. The client PC 30 is provided with a scanner 32 and/or a printer 33 as an option.

The scanner 32 is a scanner using a CCD (Charged Coupled Device) or the like, and outputs the dotted image data which is binary data by scanning the original. The printer 33 is a printer device adopting an electrophotographic method or the like, carries out printing, as a hard copy, of the image data received by the facsimile communication from other facsimile server devices, and carries out printing of the character data.

A display 34 is a displaying device such as a LCD (Liquid Crystal Display), a CRT (Cathode ray tube) display, and the like, and displays the working condition of the client PC 30, the image data of the original to be transmitted, and the received image data.

An operation unit 35 is a keyboard or the like, and provided for inputting character data or an instruction command.

A ROM (Read Only Memory) 36 stores, in advance, programs of various software which is necessary for the working of the client PC 30 and is to be performed by the main control unit 31. Moreover, a RAM (Random Access Memory) 37 is formed by an SRAM (Static Random Access Memory), a DRAM (Dynamic Random Access Memory), an SDRAM (Synchronous DRAM) or the like, and is used as a working area of the main control unit 31 to store temporary data generated at the time the program is performed.

A hard disk drive 38 is a storing device provided with a storing medium, stores an application program to be performed by the main control unit 31, and has an image memory. For example, a browser program for accessing the data on the WWW web or the like is stored in a browser program area 38a within the hard disk drive 38.

By the instruction from the operation unit 35, the browser program within the browser program area 38a is performed so as to transmit an HTTP request message via the LAN 70 to execute the HTTP task within the facsimile server machine 20, and as a response to this, an HTTP response message is received. Alternatively, by accessing an HTTP server device (not shown in the drawings) which is located at a different place, via the router device 60 and the Internet 90 and by operating of the operation unit 35, an HTTP request message can be transmitted for executing another HTTP task, and as a response to this, an HTTP response message can be received. As in the manner stated above, necessary information or data is downloaded and stored in the hard disk drive 38, for example. Further, a LAN interface 42 is connected to the LAN 70, receives a signal or data from the LAN 70, and transmits a signal or data to the LAN 70, and then carries out interface processing such as signal converting or protocol converting.

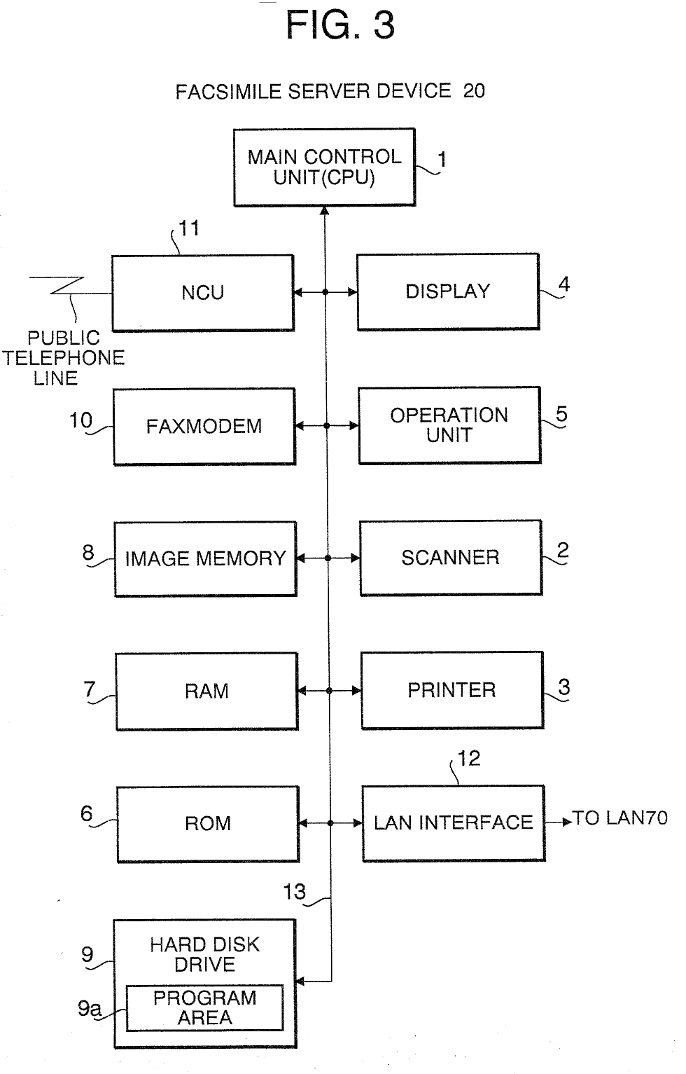

As shown in FIG. 3, the facsimile server device 20 comprises HTTP server means, image converting means, image thumbnail displaying means, and image downloading means as well as a conventional facsimile communication function such as a G3 method. The main control unit 1 is formed so as to include the CPU specifically, and is connected to the following software units via the bus 13, controls the hardware units, and also carries out various software to be mentioned later on.

The scanner 2 scans the original by the scanner using the CCD or the like, and outputs the dotted image data which is binary data. The printer 3 is a printer device using the electrophotographic method or the like, and prints, on the paper, the image data which is received by the facsimile communication from other facsimile devices or prints the character data.

The display 4 is a displaying device such as the liquid crystal display, and the CRT display, and displays the working condition of the facsimile server device 20, the image data of the original to be transmitted, and the received image data. The operation unit 5 comprises the character keys necessary for the operation of the facsimile server device 20, the ten-key numeric pad, the speed dial key, the one-touch dial key, the various function keys and/or the like. Further, by adopting a touch panel method on the display 4, the touch panel may substitute for a part of or all of the various keys within the operation unit 5.

The ROM 6 stores, in advance, the program of various software which is to be carried out by the main control unit 1, and is necessary for the working of the facsimile server device 20. The RAM 7 is formed with the SRAM, the DRAM, the SDRAM, or the like, and is used as the working area of the main control unit 1 to store the temporary data generated when the program is carried out. Further, when a flash memory is used for the RAM 7, even in the case power supply from the power source is shut off due to blackout, transferring of the device, and so forth, the contents of the data is not lost.

The image memory 8 is formed with the DRAM or the like, and stores the image data to be transmitted and the received image data. Furthermore, the hard disk drive 9 is a storing device with the storing medium, and includes a program area 9a which stores the HTTP server means, the image converting means, the image thumbnail displaying means, and the image data downloading means. According to the embodiment of the present invention, the hard disk drive 9 may be replaced with the RAM or a compact flash memory.

The faxmodem 10 is connected to the public telephone line (L), and is a modem having the function of the faxmodem for the normal facsimile communication. The NCU (Network Control Unit) 11 is a hardware circuit which carries out the closing and releasing working of the direct current loop or the like of the analogue public telephone line (L), and is provided with the automatic dialing function, and connects the faxmodem 10 to the public telephone line (L) when necessary. The NCU 11 carries out the detection of ID receiving terminal starting signal of caller ID notification service and the normal telephone calling signal, and when necessary, the NCU 11 can transmit a first response signal and a second response signal of the caller ID notification service. Further, the NCU 11 can be connected to a digital line (for example, ISDN (Integrated Services Digital Network) line) of a base band transmission method via a terminal adaptor and the DSU (Digital Service Unit).

Furthermore, the LAN interface 12 is connected to the LAN 70, receives the signal or the data from the LAN 70, and transmits the signal or the data to the LAN 70, and carries out the interface processing such as the signal conversion or the protocol conversion.

The facsimile server device 20 formed in the manner stated above comprises the HTTP server means, the image converting means, the image thumbnail displaying means, and the image data downloading means. By the facsimile communication function, the dotted image data forwarded from each of the client PCs 30-1 to 30-N and the dotted image data scanned by the scanner 2 is coded by the software in accordance with the coding method such as the MH, the MR, and the MMR which are defined in the standard of the facsimile communication, and then transmitted to the facsimile machine of the other end, while the coded data received from the facsimile machine of the other end is decoded into the image data by the software, is stored into the image memory 8, and is printed out by the printer 3 when necessary.

According to the first embodiment of the present invention, the coding and the decoding processing of the facsimile data is carried out at the side of the facsimile server device 20, but the client PCs 30-1 to 30-N may have the program for carrying out the coding and decoding processing of the facsimile, and the coding and decoding processing of the facsimile may be carried out by each of the client PCs 30-1 to 30-N. In such a case, the image data to be transmitted through the LAN 70 and the image data stored in the image memory 8 is the coded image data. The coded image data is not to be limited to the coded image data of the facsimile, and it may be specific image data formats such as GIF (Graphics Interchange Format), JPEG (Joint Photographic Experts Group), and PDF (Portable Document Format). In this case, the image data of these formats may be converted into the coded format of the facsimile at the facsimile server device 20.

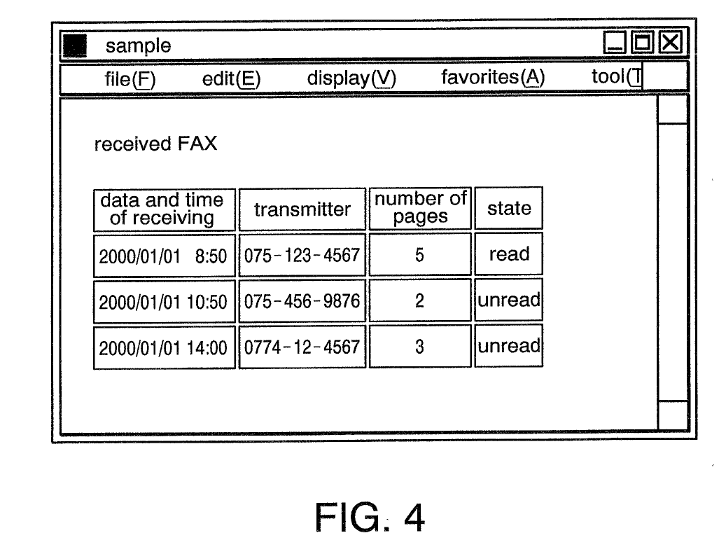

FIG. 4 is a view showing the screen concerning “the image data of the received facsimile” which is displayed when accessing the HTTP server means of the facsimile server device 20 from the client PC 30 or the like. The image data received by the facsimile server device 20 via the public switched telephone network 80, for example, or the image data obtained by being scanned by the scanner 2 is stored in the hard disk drive 9, and the notification report of such a fact is sent to the corresponding client PC 30 in the form of the electronic mail, together with the URL (Uniform Resource Locator) to be referred to.

At the client PC 30 side, when clicking the URL to be referred to, the WEB browser starts automatically, and for example, the corresponding displaying screen as shown in FIG. 4 is displayed. FIG. 4 shows a list of the contents of “the image data of the received facsimile”. The date and time of the receiving, the telephone number of the transmitter, the number of pages, the read state or unread state are displayed concerning each image data. When clicking the section of “read state” or “unread state”, the displaying screen shown in FIG. 5 appears.

In FIG. 5, the screen to be displayed is shown when clicking section of “read state” or “unread state” concerning “the image data of the received facsimile” of FIG. 4. FIG. 5 is a view showing the screen for generating an indicating signal which indicates the thumbnail displaying and the image format conversion which is performed at the time of the downloading, concerning the image data of the received facsimile.

When clicking the “thumbnail displaying of the image” shown in the fourth line of FIG. 5, the image data of the two pages is displayed on the screen under the thumbnail format. The thumbnail display is to display the small picture for checking the contents before the file is actually opened. Moreover, at the column of the image conversion, by each page, it is possible to indicate whether or not to perform downloading, and indicate the paper size, the resolution, the coding method, and the file format (the circle with the centered dot is the indicated matter). When the format of the image conversion is indicated, and then the “downloading” at the bottommost section is clicked, the corresponding image data is converted into the image by the image converting means provided in the program area 9a shown in FIG. 3, and then the image data is downloaded by the client PC.

When carrying out the HTTP task of the facsimile server device 20 from each client PC 30, the known HTTP is used as a procedure.

According to the first embodiment of the present invention, the facsimile server device 20 of FIG. 3 is provided with the HTTP server means, and forms the server device comprising a complex function of FAX means, electronic mail means, and printing means. The facsimile server device 20 accumulates the image data of the received facsimile, the electronic mail or the like within the server, and by accessing from the WEB browser on the client PC 30, the received originals can be browsed or downloaded. In such a case, by creating links such that a key sort, thumbnail displaying, information of the transmitter, and the like of the received image data are formed as titles, and by clicking them, the original can be browsed or downloaded.

In such a case, as shown in FIG. 5, by making structure such that on the program of the CGI (Common Gateway Interface), it is possible to select which page is to be downloaded or determine whether or not to convert a format, conversion and downloading of the image data can be carried out at the server side by inputting the paper size, the resolution, the coding method, and/or the like from the browser. In this manner, a portable terminal and a PDA (Personal Digital (Data) Assistants) can reduce the size of the data and/or obtain the necessary part of the data when the portable terminal and the PDA obtains the data which is addressed to themselves from the outside.

As in the manner stated above, according to the first embodiment of the present invention, the facsimile server device 20 is a server device with the facsimile function which is connected to the client PCs 30-1 to 30-N via the public line such as the public switched telephone network 80 and/or the LAN 70. Moreover, the facsimile server device 20 comprises storing means which stores the received image data and the scanned image data, and converting means which converts the stored image data to the image data in the specific format, based on the indication message data by the HTTP browser of each of client PCs 30-1 to 30-N. The facsimile server device 20 further includes displaying means for displaying the stored image data in a thumbnail, and downloading means for downloading the converted image data to the client PCs 30-1 to 30-N. In addition, the program area 9a for these means is provided within the hard disk drive 9. Therefore, even in the case of the terminal device such as the PDA or the portable terminal having the image processing ability which is low compared with the personal computer, it is possible to refer to the image data under the most appropriate condition corresponding to each terminal device.

### Second Embodiment

According to the first embodiment, an example of the facsimile server device 20 is described, but the present invention is not to be limited to such a case, and it can be applied to a communication terminal device which is connected to the public line such as the public switched telephone network or the public digital line network, for example, a telephone machine or a data communication terminal.

### Third Embodiment

According to the first and second embodiments of the present invention, the facsimile server device 20 comprises both the HTTP server means and the image converting means, but the present invention is not to be limited to such a case, and the facsimile server device 20 may be provided with the only facsimile communication means, and a separate HTTP server device may be provided with the HTTP server means for storing image data and the image converting means. Furthermore, the facsimile server device 20 may be provided with the facsimile communication means and the image converting means, and a separate HTTP server device may be provided with the HTTP server means for storing image data.

### Fourth Embodiment

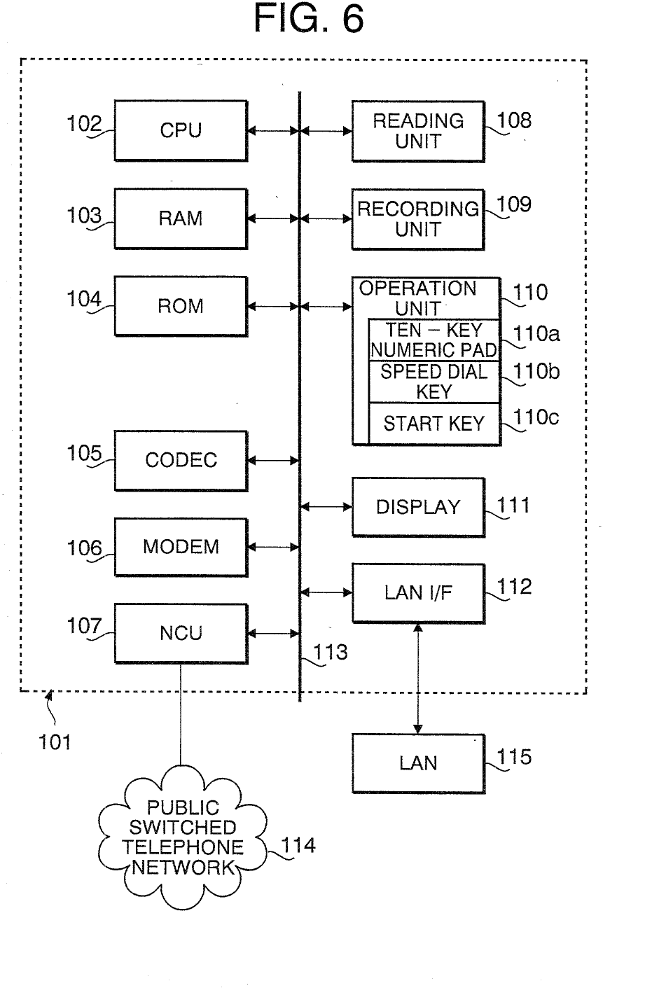

In FIG. 6, the specific structure of facsimile server means 101 is shown according to a fourth embodiment of the present invention. The facsimile server means 101 comprises a CPU (Central Processing Unit) 102, a RAM (Random Access Memory) 103, a ROM (Read Only Memory) 104, a codec 105, a modem 106, an NCU (Network Control Unit) 107, a reading unit 108, a recording unit 109, an operation unit 110, a display 111, a LAN I/F (Local Area Network Interface) 112, and the like. The respective units are connected to each other via a bus 113 so as to carry out the communication.

The CPU 102 controls each unit which is an element of the facsimile server means 101, based on the control program stored in the ROM 104.

The RAM 103 stores temporary data which is necessary when the control program is carried out, and also functions as a storing unit for storing the image data, the facsimile number data, the electronic mail address, the transmission management data, and the like.

The ROM 104 stores the control program for controlling the entire facsimile server means 101, such as the program for the facsimile transmitting and receiving procedure or the communication procedure based on the HTTP.

The codec 105 carries out the coding processing for coding the image data scanned by the reading unit 108 by the coding method such as the MH Modified Huffman), the MR (Modified Read), the MMR (Modified Modified Read), and the like, and carries out the decoding processing for decoding the received image data.

The modem 106 modulates and demodulates the communication data in accordance with the V. 34 standard of the ITU-T (International Telecommunication Union) Recommendation or something similar to this.

The NCU 107 is a network control device for carrying out connecting and disconnecting with the public line 114 such as the PSTN (Public Switched Telephone Network).

The reading unit 108 scans the shading of the original by the image sensor such as the CCD (Charged Coupled Device), and outputs the image data converted into binary data of black and white.

The recording unit 109 adopts the electrophotographic method, the inkjet method, or the like, and records the image data onto the recording paper. For example, the image data of the original scanned by the reading unit 8 or the image data received by the facsimile is printed out by the indication of the CPU 2.

The operation unit 110 comprises a ten-key numeric pad 110a for inputting the facsimile number or the like, a speed dial key 110b for calling by the speed dial number, a start key 110c for carrying out the starting or the like of the scanning work of the original, and various operations are carried out by the operation unit 110.

The display 111 is a displaying device such as the LCD (Liquid Crystal Display), the CRT display, or the like, and displays the working condition of the facsimile server means 101, and the guide message or the like at the time of the operation.

The LAN I/F 112 is an interface for connecting with the LAN 115, and for example, the facsimile communication by the electronic mail, and the communication with the HTTP server are carried out via this interface.

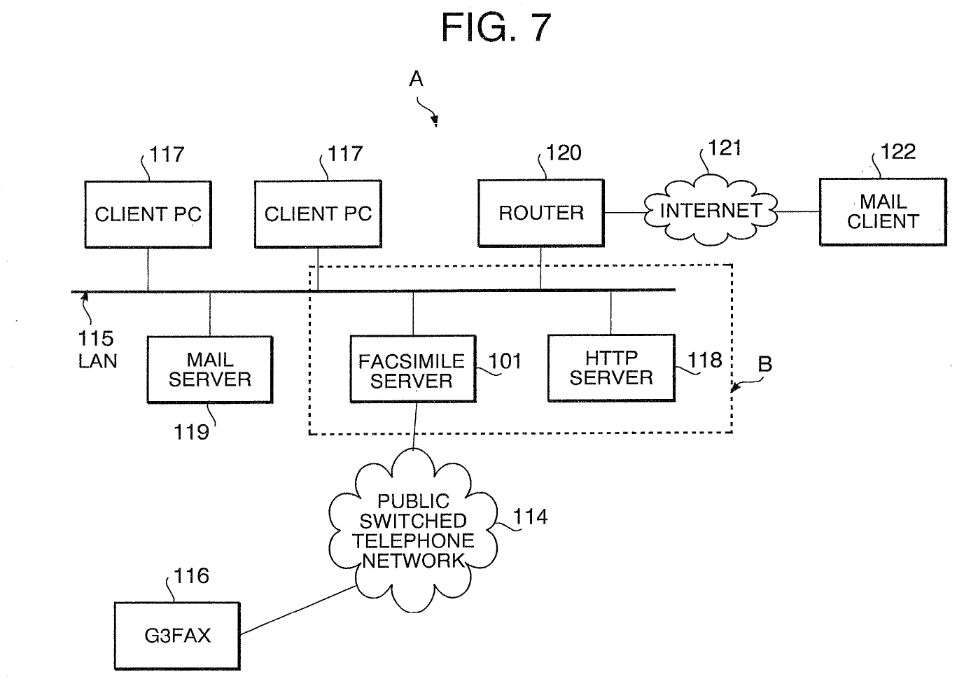

Next, the facsimile server means 101 formed in the manner state above will be described in conjunction with the facsimile transmitting and receiving work in a network system (A) shown in FIG. 7, for example.

In the network system (A), the facsimile server means 101 is connected capable of carrying out the communication with the G3 FAX 116 through the public line 114, and with the client PC 117 through the LAN 115 which is a private line.

Therefore, the facsimile server means 101 can transmit the facsimile to the G3 FAX 116. Moreover, the facsimile server means 101 can print out the image data received by facsimile from the G3 FAX 116, by using the recording unit 109, and deliver the image data received by facsimile from the G3 FAX 116, to the client PC 117 through the LAN 115. Furthermore, the facsimile server means 101 is connected with a mail server 119 and a router 120 through the LAN 115 so as to carry out communication with them. Since the router 120 is connected with a mail client 122 through the Internet 121 so as to carry out communication with the mail client 122, the facsimile server means 101 can carry out transmission and reception of image data with the mail client 122 via the mail server 119 or the like by electronic mail.

Moreover, the facsimile server means 101 is connected with the HTTP server means 118 through the LAN 115 so as to carry out communication with the HTTP server means 118, and the HTTP server means 118 is connected with the client PC 117 through the LAN 115 so as to carry out communication with the client PC 117. The HTTP server means 118 is capable of carrying out the communication with the facsimile server means 101 and the client PC 117, based on the HTTP.

Next, in the network system (A), a facsimile server device (B) which includes the facsimile server means 101 and the HTTP server means 118 will be described.

First, the HTTP (Hyper Text Transfer Protocol) to be used will be described. The communication among the facsimile server means 101, the HTTP server means 118, and the client PC 117 on the LAN 115 can be carried out based on the HTTP. The HTTP is a protocol for communication by transmitting and receiving the HTTP message reciprocally between the HTTP client and the HTTP server.

The HTTP message is comprised of a request to be transmitted from the client PC 117 or the facsimile server means 101, and a response returned by the HTTP server means 118 in response to the request. The request comprises an HTTP message body including a method for demanding the work, URI (Uniform Resource Identifier) showing the destination of the communication, a header showing the information of the data, and the data to be attached when necessary. The response comprises an HTTP message body including a status code for showing the work of the HTTP server relating to the demand of the work from the client, the header showing the information of the data, and the data to be attached when necessary. According to the above-described facsimile communication system, for example, the image data, the transmission management data, and the control data such as the transmission indication is attached to the HTTP message body, and by carrying out the communication based on the HTTP reciprocally among respective devices, the control is carried out. Further, the detail of the HTTP and the URI are shown as RFC 1945 or the like (HTTP), and RFC 2396 or the like (URI) respectively in the RFC (Request For Comments,) publicized by the IETF (The Internet Engineering Task Force).

Next, HTML (Hyper Text Markup Language) document to be used in the communication based on the HTTP will be described. The HTML document is a document of a format for linking other document or data with the HTML document, by writing, into the HTML document, the place (URI) where the substance of other document or data is saved in an appropriate storing medium. Moreover, it is possible to easily refer to other document or data from the HTML document. According to the facsimile communication system, the HTTP server means composes the HTML document appropriately as the index to the saved image data or the like, and thereby, it becomes possible to facilitate referring to the saved data or the like. The detail of the HTML is shown in RFC 1866 or the like.

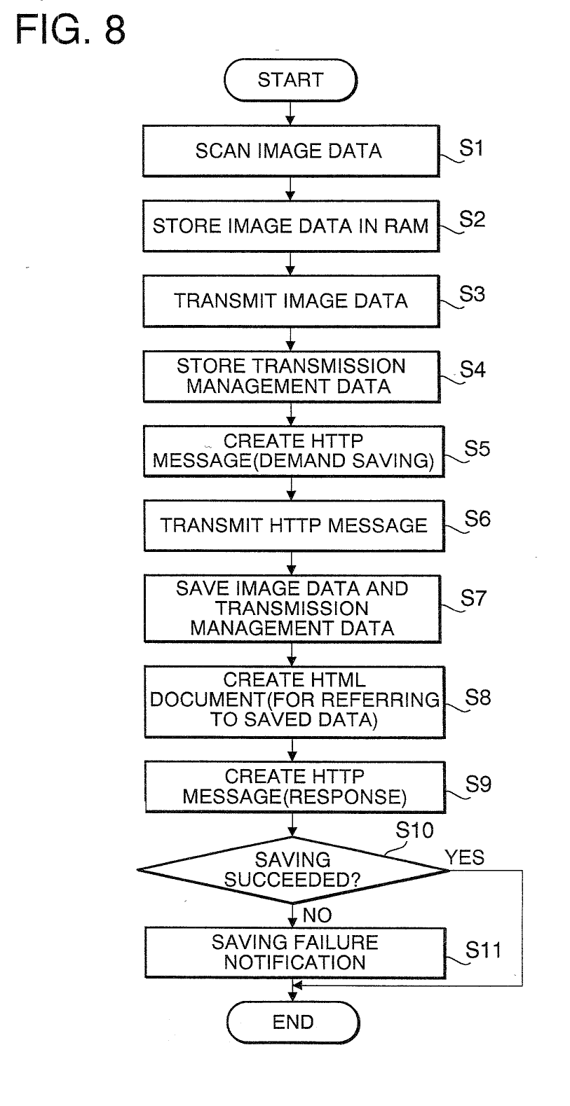

Next, based on the flow chart shown in FIG. 8, it will be described of the work within the facsimile server device (B) when the image data of the original set in the reading unit 108 is transmitted.

First, when the operator presses down the start key 110c, the facsimile server means 101 scans the image data of the original set in the reading unit 108 (S1). Next, the scanned image data is coded by the codec 105, and stored into the RAM 103 (S2). The scanned image data is transmitted to the G3 FAX 116 or the mail client 122 (S3). Then, the RAM 103 stores the transmission management data including the date and time of transmission, the number of pages of transmitted image data, the facsimile number, the data of the destination such as the mail address, and the transmission result received from the destination, regarding the transmitted image data (whether or not the image data has been delivered to the destination) (S4).

Next, the facsimile server means 101 adds the HTTP header to the image data stored in S2 and the transmission management data stored in S4, and forms the HTTP message for requiring the HTTP server means 118 to save the image data and the transmission management data (S5). Specifically, for example, the HTTP server means 118 is specified as the request URI (communication destination), and by a PUT method for demanding the saving of the attached data, the HTTP message (request) is composed for demanding that the image data and the transmission management data which are attached to the message body should be saved.

Then, the facsimile server means 101 transmits the HTTP message formed in S5 to the HTTP server means 118 through the LAN 115 (S6).

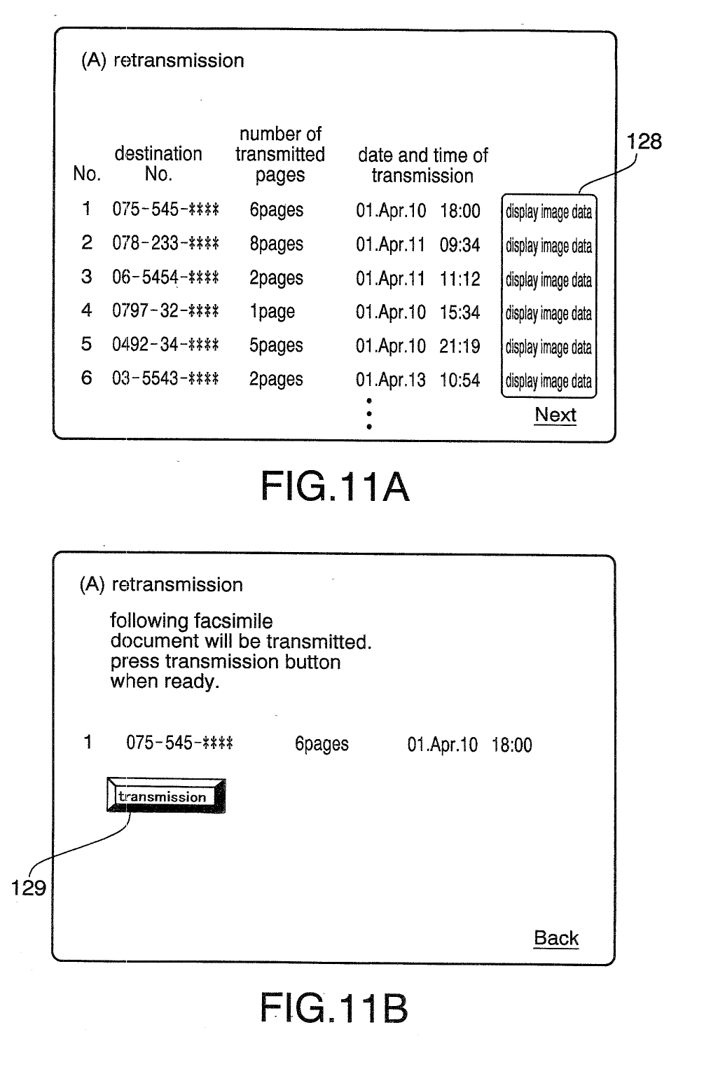

Then, the HTTP server means 118 analyzes the received HTTP message, and in accordance with the demand for saving of the HTTP message, the image data and the transmission management data attached to the HTTP message is saved by the HTTP server means 118 as the saved data (S7). Subsequently, the HTML document is formed which is referred to at the time of retransmitting for example, and which displays a list of the saved data as shown in FIG. 11A (S8). Next, the notification of whether or not the saving of the saved data has succeeded is transmitted to the facsimile server means 101 as the HTTP message (response) (S9).

The facsimile server means 101 performs judging based on the received HTTP message (S10), and when judging that the saving of the saved data has succeeded (for example, in the case the status code 201 is returned as the response, the transmitted image data is saved by the HTTP server means 118, and a new URI for referring is given), the series of work is ended.

When judging that the saving has resulted in a failure (for example, in the case the status code 503 returns as the response, and the HTTP server means 118 cannot carry out the saving demand due to overload), the fact of the failure of the saving is displayed on the display 111, and is notified to the operator (S11).

Next, concerning the case in which the image data transmitted by the facsimile server means 101, and the transmission management data formed accompanying the transmission is saved in the HTTP server means 118, and the client PC 117 causes the facsimile server means 101 to retransmit the transmitted image data, the following listed work (A) to (E) will be described.

(A) retransmission (transmit image data to the same destination again).

(B) partial retransmission (retransmit a part of the pages of the image data to the same destination).

(C) transmission to the different destination.

(D) deletion of the saved data.

(E) thread display of the saved data.

In the following description, it is assumed that the browser operates on the client PC 117 as the HTTP client. The browser converts the instruction of the operator to the instruction for the communication based on the HTTP, and is the interface for displaying the data such as the received image data and the transmission management data such that the client PC 117 can view such data.

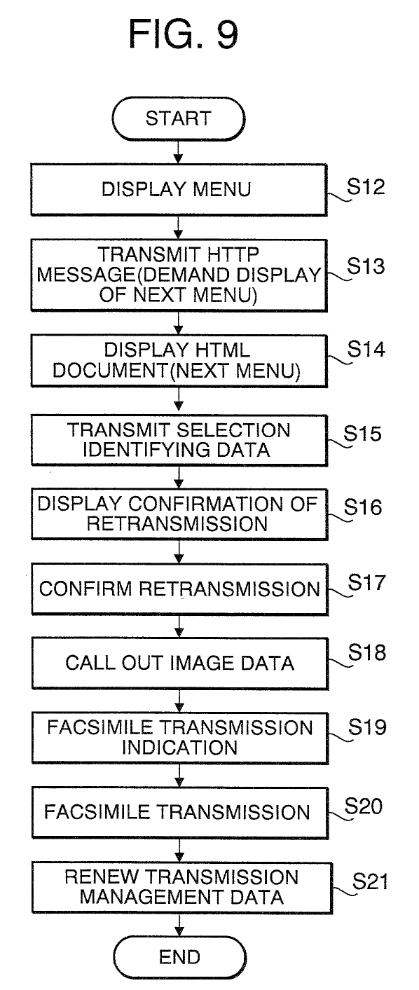

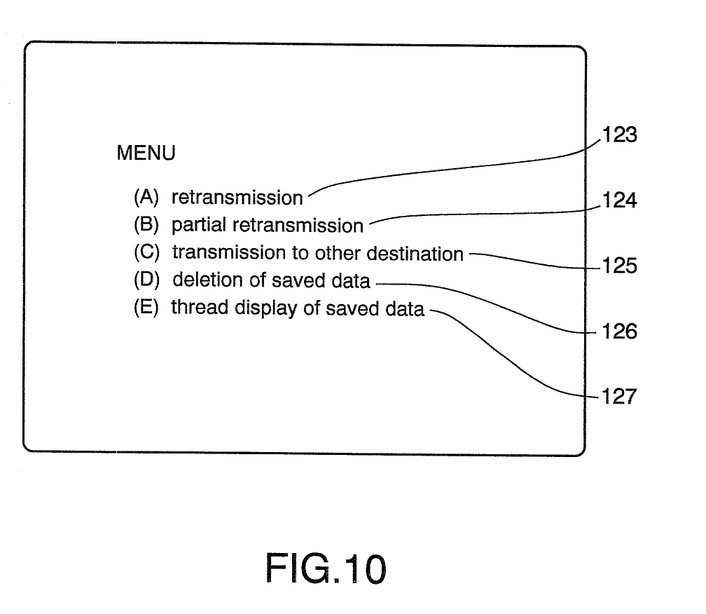

First, the case (A) of the retransmission will be described based on the flow chart shown in FIG. 9. When the operator indicates the URI showing the HTTP server means 118 on the browser of the client PC 117, for example, the menu by the HTML document is displayed as shown in FIG. 10 (S12). When the operator selects “(A) retransmission” 123 by using an inputting device such as a mouse, the client PC 117 transmits, to the HTTP server means 118, through the LAN 115, the HTTP message for demanding the display of the HTML document which shows the next menu linked to “(A) retransmission” 123 (S13).

Next, as shown in FIG. 11A, for example, the HTML document which is received from the HTTP server means 118, and which is used for selecting the image data to be retransmitted is displayed on the browser of the client PC 117 (S14). A list of the saved data (the image data and the transmission management data) which was saved previously is displayed in the HTML document, and the HTML document is linked to the image data so as to facilitate reference to the image data and the like. For example, when selecting the “image data display” 128 of the list, the corresponding image data is displayed on the browser.

When the operator selects the item of the saved data corresponding to the image data to be retransmitted on the display of the browser, the client PC 117 transmits, to the HTTP server means 118, the selection identifying data showing the selected saved data as the HTTP message (S15).

Subsequently, the HTTP server means 118 which received the HTTP message transmitted in S15 displays the HTML document for confirming the retransmission on the browser as shown in FIG. 11B (S16), and after the operation of the “transmission” 129 is confirmed by the operator (S17) corresponding image data and the data of the destination is called out from the saved data (S18), and the image data and the data of the destination is transmitted as the HTTP message to the facsimile server means 101, along with the transmission indicating data for indicating the facsimile transmission (S19).

The facsimile server means 101 which received the transmission indicating data of S19, the image data and the data of the destination transmits the image data through the public switched telephone network 114 to the terminal of the destination which is shown in the data of the destination by facsimile (S20). Then, the transmission management data obtained at the time of the transmission is transmitted as the HTTP message to the HTTP server means 118 so as to add this obtained transmission management data to the transmission management data in the saved data which are saved in the HTTP server means 118 (S21). At this time, the transmission management data such as the transmission result may be displayed on the browser of the client PC 117 in order to notify the transmission result to the operator.

Next, the case (B) of the partial retransmission will be described. The work of the partial retransmission and the work of the retransmission are almost the same. The work of the partial retransmission, however, differs from the work of retransmission in that by the work of the partial retransmission, it is possible to indicate the page of the image data to be retransmitted in the retransmission work. In other words, when “(B) partial retransmission” 124 is selected on the display of the browser of FIG. 10, a list of the saved data is shown in the same manner as the case of the retransmission. When certain saved data is selected, although it is not shown in the drawings, the browser shows a screen for urging the operator to input the page number. Subsequently, the page number data input by the operator, and the selection identifying data showing the selected saved data is transmitted to the HTTP server means 118 as the HTTP message.

On the other hand, the HTTP server means 118 which received the HTTP message analyzes the HTTP message, calls out the image data of the page which is selected by the page number data and the data of the destination from the corresponding saved data, and transmits the image data and the data of the destination as the HTTP message to the facsimile server means 101, along with the transmission indicating data for indicating the facsimile transmission.

On the other hand, based on the received image data and the data of the destination, the facsimile server means 101 transmits the image data of the specified page to the G3 FAX 116 which is the terminal of the destination through the public switched telephone network 114 or to the mail client 122 which is the terminal of the destination through the Internet 121.

Subsequently, in the same manner as the case of the retransmission, the facsimile server means 101 transmits the transmission management data obtained at the time of the transmission, as the HTTP message, to the HTTP server means 118 so as to add this obtained transmission management data to the transmission management data in the saved data saved in the HTTP server means 118.

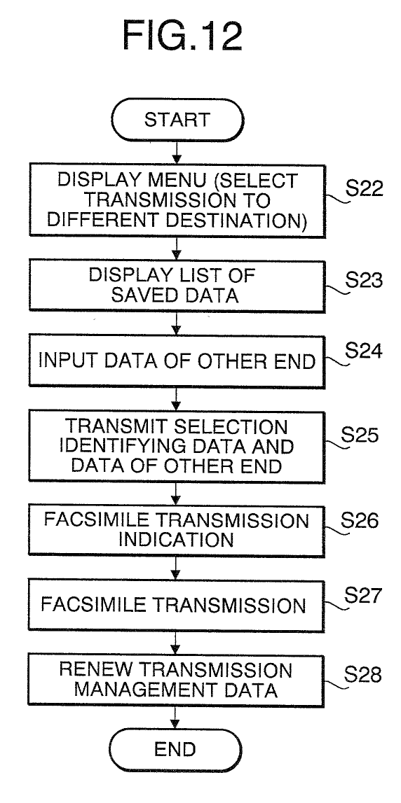

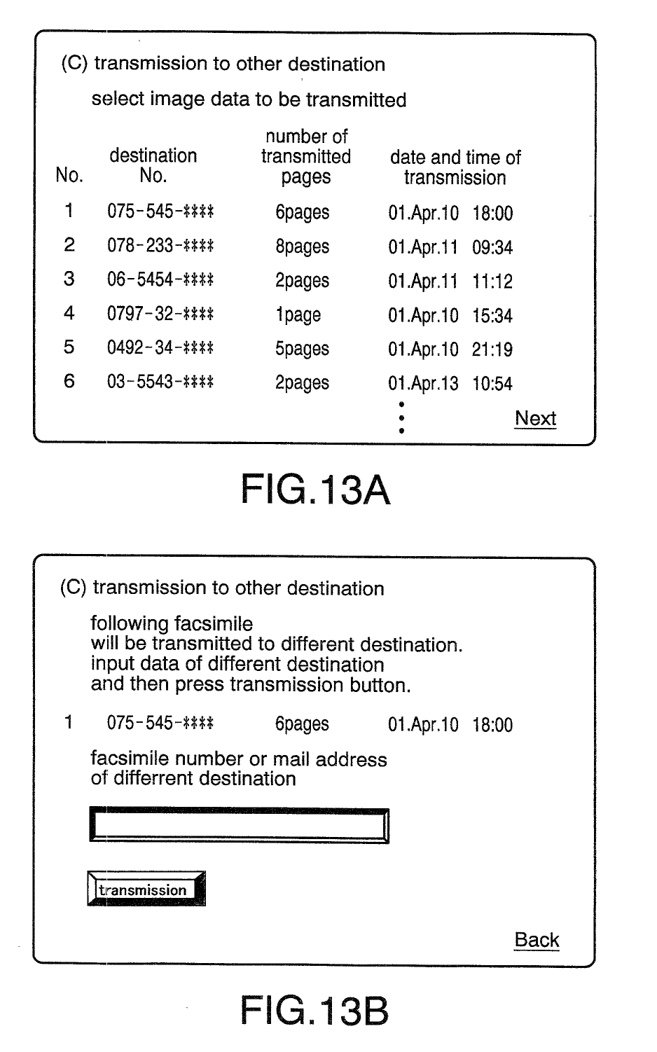

Next, the work of the case (C) of the transmission to a different destination will be described based on the flow chart shown in FIG. 12. When “(C) transmission to different destination” 125 is selected on the menu display of FIG. 10 (S22), a list of the saved data is displayed as shown in FIG. 13A in the same manner as the case of the retransmission (S23). When the saved data corresponding to the image data to be transmitted to the different destination is selected, a screen is displayed for urging the operator to input the data of the destination including the facsimile number or the mail address as shown in FIG. 13B (S24). At this time, by displaying the list of the data of the destination input in advance, the different destination can be selected.

Then, the client PC 117 transmits the selection identifying data showing the selected saved data and the input data of the destination to the HTTP server means 118 (S25).

The HTTP server means 118 analyzes the received data, and transmits the corresponding image data and the data of the destination to the facsimile server means 101, along with the facsimile transmission indication (S26).

Based on the received data of the destination which differs from the original destination, the facsimile server means 101 transmits the received image data to the G3 FAX 116 or the mail client 122 which is a terminal of the destination through the public switched telephone network 114 or the Internet 121 (S27). After the transmission, in the same manner as the case of the retransmission, the transmission management data obtained at the time of the transmission is transmitted to the HTTP server means 118, and is added to the transmission management data saved in the HTTP server means 118 (S28).

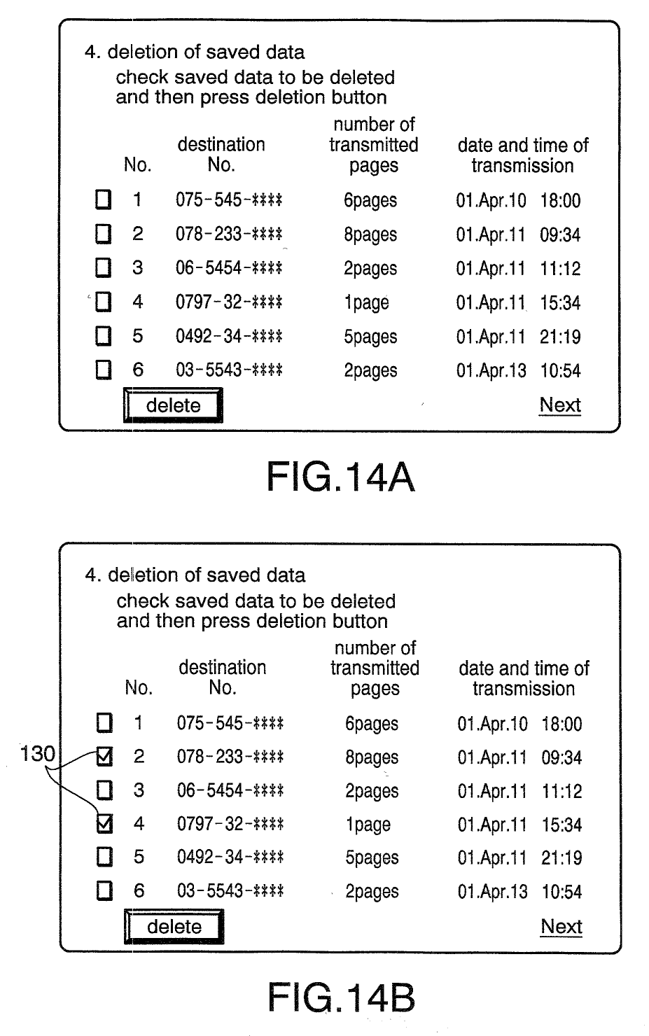

Next, the case (D) of the deletion of the saved data will be described. When “(D) deletion of the saved data” 126 is selected on the menu display of the browser shown in FIG. 10, for example, a list of the saved data as shown in FIG. 14A is displayed. When selecting the saved data to be deleted by putting marks 130 as shown in FIG. 14B, the selection identifying data which designates the selected saved data is transmitted to the HTTP server means 118.

The HTTP server means 118 deletes the corresponding saved data, in other words, the corresponding image data and the transmission management data, based on the received selection identifying data.

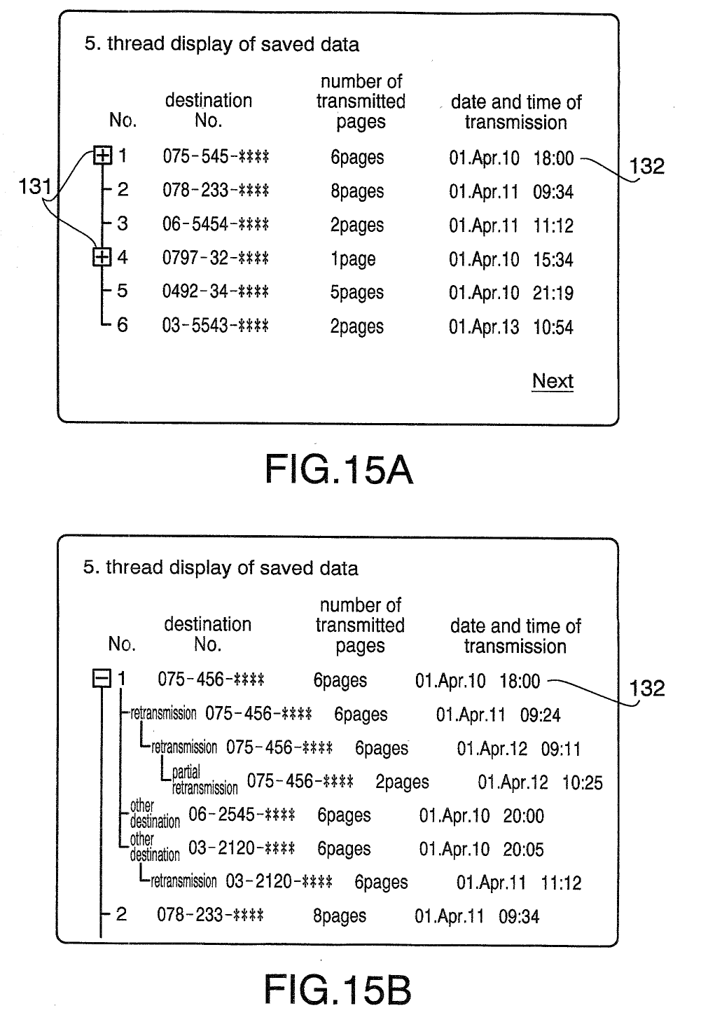

Next, the case (E) of the thread display of the saved data will be described. In FIG. 10, when “(E) thread display of the saved data” 127 is selected, for example, the thread display of the saved data is carried out as shown in FIG. 15A. In other words, when retransmission or the like of the same saved data as the saved data which was transmitted is carried out, a plus mark 131 as a root of the tree structure is put on the left end of the saved data which was transmitted first. Accordingly, it is possible to show that the retransmission or the like has been carried out.

In the example shown in FIG. 15A, when the saved data 132 on which the plus mark 131 is put is selected, as shown in FIG. 15B, the transmission form such as the retransmission is displayed by tree structure as the remaining part of the thread. In the example of FIG. 15B, the saved data 132 having the image data of six pages transmitted by facsimile to 075-545-**** on Apr. 10, 2001 becomes the root of the tree structure as the saved data which was transmitted first, and under such a root, the retransmitted saved data is classified in accordance with the destination, and displayed. When retransmission (re-retransmission) of the retransmitted saved data is carried out again, the tree structure further branches, and is displayed.

In other words, the saved data retransmitted on April 11 is re-retransmitted to the same destination on April 12, and on April 12, the partial retransmission of the image data of two pages is carried out to the same destination. Furthermore, two transmissions are made to the different destinations on April 10, and retransmission is carried out to one of the different destinations on April 11.

Further, according to the fourth embodiment of the present invention, the HTTP server means 118 and the facsimile server means 101 are provided separately to each other as the facsimile server device (B). However, the HTTP server can be provided within the facsimile server, and as one facsimile server, the function similar to the facsimile server device (B) can be realized.

What is claimed is:

1. A server device which includes HTTP server means and is connected to a client device via a private line, wherein the HTTP server means includes:
storing means for storing image data; and
converting means for converting the image data stored in the storing means into a specific image data format, based on indication generated from the client device.

2. The server device according to claim 1, wherein the private line is a LAN (Local Area Network).

3. The server device according to claim 1, further including facsimile server means, wherein the facsimile server means includes:
receiving means for receiving image data via a public line; and
outputting means for outputting the received image data to the HTTP server means.

4. The server device according to claim 3, wherein the public line is a PSTN (Public Switched Telephone Network) or the Internet.

5. The server device according to claim 3, wherein the facsimile server means further includes scanning means for obtaining image data by scanning an original, and the outputting means outputs the image data obtained by the scanning means to the HTTP server means.

6. The server device according to claim 1, wherein the HTTP server means further includes downloading means for downloading the converted image data to the client device, based on indication generated from the client device.

7. The server device according to claim 1, wherein the converting means converts the image data, concerning at least one of a paper size, resolution, a coding method, and a file format.

8. The server device according to claim 1, wherein the HTTP server means further includes determining means for determining whether or not image data has been stored in the storing means, and notifying means for sending, to the client device, a notification report to the effect that the image data has been stored in the storing means, when the image data is stored in the storing means.

9. The server device according to claim 8, wherein the notifying means sends the notification report in the form of electronic mail.

10. A network system in which a client device is connected to a server device via a private line,
wherein the server device includes storing means for storing image data, and converting means for converting the image data stored in the storing means into a specific image data format, based on indication generated from the client device, and the client device includes displaying means for displaying information concerning the image data stored in the storing means.

11. The network system according to claim 10, wherein the information concerning the image data includes at least one of date and time of receiving, a telephone number of a transmitter, the number of pages, and a read state or an unread state, regarding each of the image data.

12. The network system according to claim 11, wherein the image data stored in the storing means is displayed in a thumbnail display by the displaying means.

13. A server device including HTTP server means and facsimile server means, wherein the facsimile server means includes:
transmitting means for transmitting image data through a public line;
transmission management data composing means for composing transmission management data of the image data transmitted by the transmitting means; and
outputting means for outputting, to the HTTP server means, through a private line, the image data transmitted by the transmitting means and the transmission management data.

14. The server device according to claim 13, wherein the private line is a LAN (Local Area Network).

15. The server device according to claim 13, wherein the public line is a PSTN (Public Switched Telephone Network) or the Internet.

16. The server device according to claim 13, wherein the HTTP server means stores the image data and the transmission management data input by the outputting means.

17. The server device according to claim 13, wherein the transmission management data includes at least one of date and time of transmission, the number of pages, data of a destination, and a transmission result received from the destination, regarding the transmitted image data.

18. The server device according to claim 16, wherein the HTTP server means includes retransmitting means for carrying out retransmission of the stored image data, based on indication generated from the client device.

19. The server device according to claim 18, wherein the retransmitting means retransmits a part of the stored image data, based on indication generated from the client device.

20. The server device according to claim 18, wherein the retransmitting means retransmits the stored image data to a destination different from a destination to which the image data was transmitted first, based on indication generated from the client device.
